(19) United States
(12) Patent Application Publication
(10) Pub. No.: US 2025/0269926 A1
(43) Pub. Date: Aug. 28, 2025

(54) BICYCLE FRONT FORKS

(71) Applicant: SRAM, LLC, CHICAGO, IL (US)

(72) Inventors: BRONSON STAGNER, COLORADO SPRINGS, CO (US); TIMOTHY LYNCH, COLORADO SPRINGS, CO (US); ALEXANDER J ROSENBERRY, COLORADO SPRINGS, CO (US); MICHAEL MAXWELL, COLORADO SPRINGS, CO (US)

(73) Assignee: SRAM, LLC, CHICAGO, IL (US)

(21) Appl. No.: 18/584,999

(22) Filed: Feb. 22, 2024

(51) Int. Cl. B62K 25/08; B62K 21/02; B62K 25/04

(52) U.S. Cl. CPC B62K 25/08; B62K 21/02; B62K 2025/048

(57) ABSTRACT

A front fork comprises a leg including a first tube and a second tube. The first tube has a first end and a second end opposite the first end. The second tube has a third end and a fourth end opposite the third end. The first and second tubes are configured in a telescopic arrangement. The first and second tubes are moveable between a fully extended position and a fully compressed position. The front fork also includes a bumper disposed in the second tube near the fourth end. The bumper is to be contacted during a bottoming-out event. A position of the bumper is adjustable in the second tube.

### FIELD OF THE DISCLOSURE

This disclosure relates generally to bicycle components and, more specifically, to bicycle front forks with bumpers.

### BACKGROUND

Bicycles are known to have suspension components. Suspension components are used for various applications, such as cushioning impacts, vibrations, or other disturbances imparted to the bicycle during use. A common application for suspension components on bicycles is for cushioning impacts or vibrations experienced by the rider when the bicycle is ridden over bumps, ruts, rocks, potholes, and/or other obstacles. These suspension components include rear and/or front wheel suspension components. For example, some bicycles include a front fork with telescoping legs that incorporate a spring and/or damper system. The front fork compresses and expands when riding over obstacles to help cushion impacts and/or vibrations felt by the rider.

### SUMMARY

An example front fork for a bicycle disclosed herein includes a leg including a first tube and a second tube. The first tube has a first end and a second end opposite the first end, and the second tube has a third end and a fourth end opposite the third end. The first and second tubes are configured in a telescopic arrangement. The first and second tubes are moveable between a fully extended position and a fully compressed position. The example front fork also includes a bumper disposed in the second tube near the fourth end. The bumper is to be contacted during a bottoming-out event before the first and second tubes reach the fully compressed positioned. A position of the bumper is adjustable in the second tube.

An example front fork for a bicycle disclosed herein includes a leg including an upper tube and a lower tube. The upper tube has a first top end and a first bottom end, and the lower tube has a second top end and a second bottom end. The upper and lower tubes are configured in a telescopic arrangement with the first bottom end of the upper tube disposed in the lower tube. The example front fork also includes a bumper disposed in the lower tube near the second bottom end and an adjuster pin to cause axial movement of the bumper in the lower tube. The bumper is moveable between a lower-most position in which a top of the bumper is a first distance from the second bottom end of the lower tube and an upper-most position in which the top of the bumper is a second distance from the second bottom end of the lower tube, the second distance being greater than the first distance.

### BRIEF DESCRIPTION OF THE DRAWINGS

FIG. 1 is a side view of an example bicycle that may employ any of the example

front forks disclosed herein.

FIG. 2 is perspective view of an example front fork that can be implemented on the example bicycle of FIG. 1.

FIG. 3 is a cross-sectional view of the example front fork of FIG. 2 taken along line A-A of FIG. 2 and showing an example jounce bumper in one of the legs.

FIG. 4A is an exploded view of example components of the leg of the example front fork of FIG. 3 including the example jounce bumper.

FIG. 4B is an exploded view of the same components of FIG. 4A shown in cross-section.

FIG. 5A is an enlarged view of the callout of FIG. 3 showing the example jounce bumper in a lower-most position.

FIG. 5B shows the example jounce bumper in an upper-most position.

FIG. 6A is a cross-sectional view showing the example jounce bumper in the lower-most position and when an example seal head is making initial contact with the example jounce bumper during a bottoming-out event.

FIG. 6B shows the example jounce bumper in the lower-most position after being deformed and/or compressed by the example seal head during the bottoming-out event.

FIG. 7A is a cross-sectional view showing the example jounce bumper in the upper-most position and when an example seal head is making initial contact with the example jounce bumper during a bottoming-out event.

FIG. 7B shows the example jounce bumper in the upper-most position after being deformed and/or compressed by the example steelhead during the bottoming-out event.

FIG. 8 is a cross-sectional view of a bottom portion of a leg showing an example jounce bumper used in connection with a spring or damper having an adjustment rod.

The figures are not to scale. Instead, the thickness of the layers or regions may be enlarged in the drawings. In general, the same reference numbers will be used throughout the drawing(s) and accompanying written description to refer to the same or like parts.

Descriptors “first,” “second,” “third,” etc. are used herein when identifying multiple elements or components that may be referred to separately. Unless otherwise specified or understood based on their context of use, such descriptors are not intended to impute any meaning of priority or ordering in time but merely as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

### DETAILED DESCRIPTION

Bicycles are known to have front forks that function as a suspension component. For example, a front fork typically includes a crown, a steerer tube extending upward from the crown, and two legs extending downward from the crown. Each leg has a first tube, in one example an upper cylindrical tube that is coupled to the crown and second tube, in one example a lower cylindrical tube that is to be connected to the front wheel. The upper and lower cylindrical tubes are arranged in a telescopic relationship that enables the front fork to compress and expand to absorb shocks and vibrations. Some front forks include spring and damper systems. For example, some front forks include a damper incorporated into one of the legs and a spring (e.g., an air spring, a coil spring) incorporated into the other leg. The spring enables the front fork to compress or contract when riding over a bump or obstacle, thereby reducing the transmission of shocks and vibrations to the rider, and then returns the fork to an expanded state after the compressive force is removed. The damper controls the speed at which the fork compresses and expands.

The upper and lower tubes of the front fork are moveable between a fully extended position and a fully compressed position, often referred to as top-out and bottom-out positions. These positions are typically defined by hard stops in which the front fork can no longer be expanded or compressed. During large compression events, such as when riding over large obstacles or landing after being airborne, the front fork can be fully compressed to its bottom-out position. This can feel harsh or jarring to the rider. Therefore, some front forks include a bumper, sometimes referred to as a jounce bumper or a bump stop. The jounce bumper is constructed of an elastomeric and/or compressible material (that is elastically deformable and/or compressible. For example, the jounce bumper may be constructed of a microcellular or foam material such as microcellular urethane. The jounce bumper is used to reduce or prevent the abrupt and harsh bottoming-out of the front fork when under full compression. Ideally the jounce bumper absorbs impact and dampens noise, vibration, and harshness by preventing the front fork from fully compacting during shock impacts caused by heavy loads (jumps), potholes, curbs, or objects (rocks). Jounce bumpers are typically integrated into the spring design for the end of travel compression, where the jounce bumper begins to ramp up force. A jounce bumper affects the compression spring curve as well as the rebound curve. One advantage of using a jounce bumper instead of a spring (e.g., a coil spring) is that the jounce bumper does not rebound nearly as quickly (i.e., exhibits a hysteresis effect). Known jounce bumpers that are installed into forks are placed at a single location and cannot be affected or changed by the end user.

Disclosed herein are example front forks with adjustable jounce bumpers. In particular, the position of the jounce bumper can be adjusted within the front fork, which affects the position at which the jounce bumper is initialized, and the upper and lower tubes start to reduce speed before reaching the bottom-out position. The adjustability affects the compression amount and impacts the rate and force of the jounce bumper. This adjustability also enables a user to control and modify the end of the spring curve, which is beneficial for achieving the rider's preferred feedback during bottoming-out events.

In some examples disclosed herein, the jounce bumper is moveable vertically (axially) within one of the legs of the front fork. In some examples, the jounce bumper position can be adjusted by rotating an adjuster pin on the bottom end of the leg. The adjuster pin can be rotated by hand without a tool or with a tool (e.g., a hex tool or Allen wrench). The example adjustable jounce bumpers disclosed herein can be incorporated into the spring side, the damper side, or both the spring and damper sides.

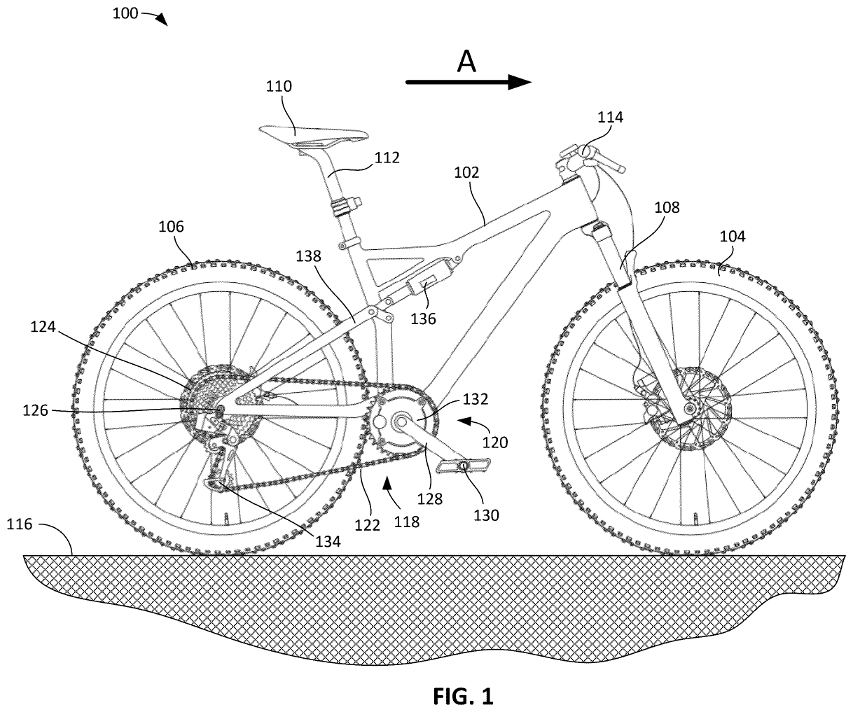

Turning now to the figures, FIG. 1 illustrates one example of a human powered vehicle on which the example suspension components disclosed herein may be implemented. In this example, the vehicle is one possible type of bicycle 100, such as a mountain bicycle. In the illustrated example, the bicycle 100 includes a frame 102 and a front wheel 104 and a rear wheel 106 rotatably coupled to the frame 102. In the illustrated example, the front wheel 104 is coupled to the front end of the frame 102 via a front fork 108. A front and/or forward riding direction or orientation of the bicycle 100 is indicated by the direction of the arrow A in FIG. 1. As such, a forward direction of movement for the bicycle 100 is indicated by the direction of arrow A. The terms “upper,” “lower,” “bottom,” “top,” “rear,” “front,” “fore,” “aft,” “vertical,” “horizontal,” “right,” “left,” “inboard,” “outboard” and variations or derivatives thereof, refer to the orientations of the exemplary bicycle 100, shown in FIG. 1, from the perspective of a user who is seated on the bicycle 100 facing handlebars 114.

In the illustrated example of FIG. 1, the bicycle 100 includes a seat 110 coupled to the frame 102 (e.g., near the rear end of the frame 102 relative to the forward direction A) via a seat post 112. The bicycle 100 also includes the handlebars 114 coupled to the front fork 108 (e.g., near a forward end of the frame 102 relative to the forward direction A) for steering the bicycle 100. The bicycle 100 is shown on a riding surface 116. The riding surface 116 may be any riding surface such as the ground (e.g., a dirt path, a sidewalk, a street, etc.), a man-made structure above the ground (e.g., a wooden ramp), and/or any other surface.

In the illustrated example, the bicycle 100 has a drivetrain 118 that includes a crank assembly 120. The crank assembly 120 is operatively coupled via a chain 122 to a sprocket assembly 124 mounted to a hub 126 of the rear wheel 106. The crank assembly 120 includes at least one, and typically two, crank arms 128 and pedals 130, along with at least one front sprocket, or chainring 132. A rear gear change device 134, such as a derailleur, is disposed at the rear wheel 106 to move the chain 122 through different sprockets of the sprocket assembly 124. Additionally or alternatively, the bicycle 100 may include a front gear change device to move the chain 122 between a plurality of chainrings 132.

The example bicycle 100 includes a suspension system having one or more suspension components. In this example, the front fork 108 is implemented as a front suspension component. The front fork 108 is or integrates a shock absorber that includes a spring and a damper, disclosed in further detail herein. Further, in the illustrated example, the bicycle 100 includes a rear suspension component 136, which is a shock absorber, referred to herein as the rear shock absorber 136. The rear shock absorber 136 is coupled between two portions of the frame 102, including a swing arm 138 coupled to the rear wheel 106. The front fork 108 and the rear shock absorber 136 absorb shocks and vibrations while riding the bicycle 100 (e.g., when riding over rough terrain). In other examples, the front fork 108 and/or the rear shock absorber 136 may be integrated into the bicycle 100 in other configurations or arrangements. Further, in other examples, the suspension system may employ only one suspension component (e.g., only the front fork 108) or more than two suspension components (e.g., an additional suspension component on the seat post 112) in addition to or as an alternative to the front fork 108 and rear shock absorber 136.

While the example bicycle 100 depicted in FIG. 1 is a type of mountain bicycle, the example suspension components (e.g., a front fork) with jounce bumpers disclosed herein can be implemented on other types of bicycles. For example, the disclosed suspension components with jounce bumpers may be used on road bicycles, as well as bicycles with mechanical (e.g., cable, hydraulic, pneumatic, etc.) and non-mechanical (e.g., wired, wireless) drive systems. The disclosed suspension components with jounce bumpers may also be implemented on other types of two-wheeled, three-wheeled, and four-wheeled human powered vehicles. Further, the example suspension components with jounce bumpers can be used on other types of vehicles, such as motorized vehicles (e.g., a motorcycle, a car, a truck, etc.).

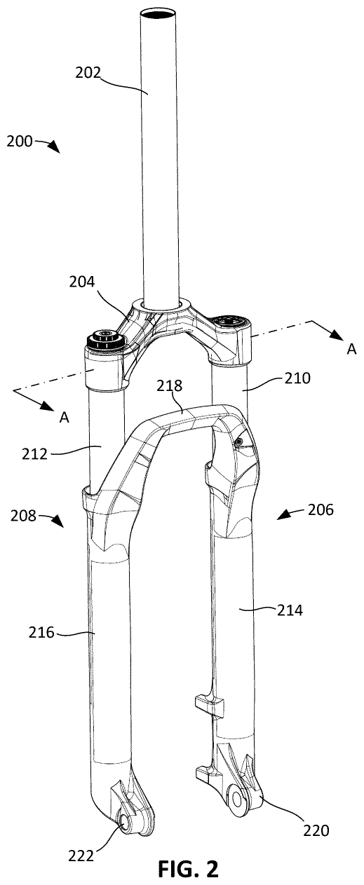

FIG. 2 is a perspective view of an example front fork 200 (a suspension component) that can be implemented as the front fork 108 and used on the bicycle 100 of FIG. 1. In the illustrated example of FIG. 2, the front fork 200 includes a steerer tube 202, a crown 204, a first leg 206, and a second leg 208. Alternatively, the fork 200 may only include one leg. The steerer tube 202 is coupled to the crown 204 and extends outward (e.g., upward) from a top of the crown 204. The steerer tube 202 is to be inserted through a head tube on the frame 102 (FIG. 1) of the bicycle 100 and coupled (e.g., via a stem) to the handlebars 114 (FIG. 1). The first and second legs 206, 208 are coupled to the crown 204 and extend outward (e.g., downward) from a bottom of the crown 204, opposite the steerer tube 202. The first and second legs 206, 208 are to be coupled to the front wheel 104 (FIG. 1).

In the illustrated example, the first and second legs 206, 208 include first and second upper tubes 210, 212, respectively, and first and second lower tubes 214, 216, respectively. The upper and lower tubes 210, 212, 214, 216 are sometimes referred to as stanchions or leg portions. The first and second upper tubes 210, 212 are coupled to and extend downward from the crown 204. The front fork 200 includes an arch 218 (sometimes referred to as a fork brace or stabilizer) coupled between the lower tubes 214, 216. In some instances, the upper tubes 210, 212 are referred to as an upper tube assembly, while the lower tubes 214, 216 and the arch 218 are referred to as a lower tube assembly. The first and second lower tubes 214, 216 include respective front wheel attachment portions 220, 222, such as holes (e.g., eyelets) or dropouts, for attaching the front wheel 104 (FIG. 1) to the front fork 200. In this example the upper and lower tubes 210, 212, 214, 216 are cylindrical, but in other examples can have a different cross-sectional shape.

The first and second upper tubes 210, 212 are slidably received within the respective first and second lower tubes 214, 216. Thus, the first and second upper tubes 210, 212 form a telescopic arrangement with the respective first and second lower tubes 214, 216. During a compression stroke, the first and second upper tubes 210, 212 move into or toward the respective first and second lower tubes 214, 216, and during a rebound stroke, the first and second upper tubes 210, 212 move out of or away from the respective first and second lower tubes 214, 216.

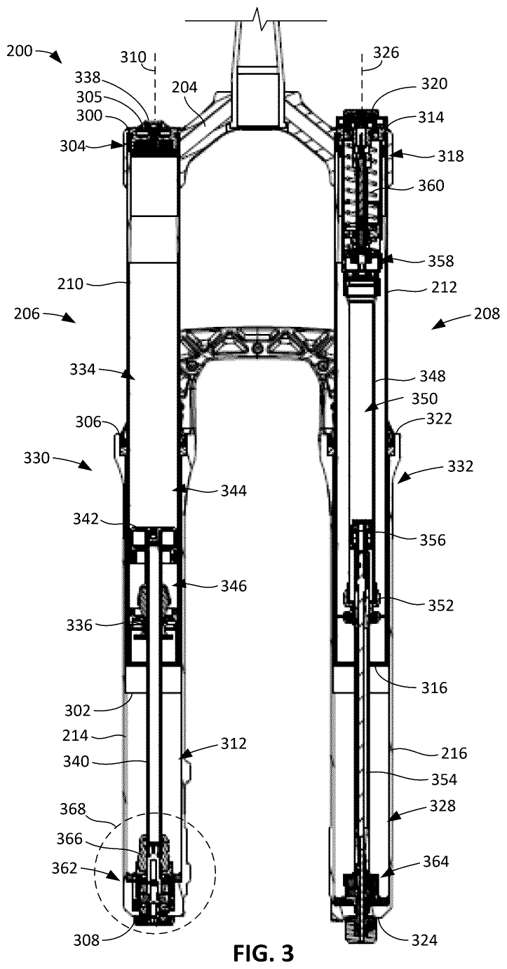

FIG. 3 is a cross-sectional view of the example front fork 200 taken along line A-A of FIG. 2. As shown in FIG. 3, the first upper tube 210 has a first end 300, referred to herein as a top end 300, and a second end 302, referred to herein as a bottom end 302, opposite the top end 300. The top end 300 is coupled to the crown 204. In the illustrated example, a portion of the first upper tube 210 extends into an opening 304 in the crown 204. In some examples, the first upper tube 210 is coupled to the crown 204 by a cap 305 that is threadably coupled to the top end 300 of the first upper tube 210. Additionally or alternatively, the first upper tube 210 can be coupled to the crown 204 via another mechanical and/or chemical fastening technique (e.g., threaded fasteners, welding, an adhesive, etc.). The first lower tube 214 has a third end 306, referred to herein as a top end 306, and a fourth end 308, referred to herein as a bottom end 308, opposite the top end 306. The first upper tube 210 is inserted into the first lower tube 214. In particular, the bottom end 302 of the first upper tube 210 is disposed within the first lower tube 214. This type of configuration is sometimes referred to as a right side up fork. Alternatively, the first lower tube is inserted into the first upper tube. This type of configuration is sometimes referred to as an inverter fork. The top end 300 of the first upper tube 210 and the bottom end 308 of the first lower tube 214 form first and second distal ends of the suspension component. During compression, the top end 300 and the bottom end 308 are moved toward each other, and during extension or rebound, the top end 300 and the bottom end 308 are moved away from each other. Thus, the first upper and lower tubes 210, 214 form a telescopic arrangement. The first upper and lower tubes 210, 214 are moveable along a central axis 310 of the first leg 206. The first upper and lower tubes 210, 214 define an interior chamber or region 312.

The second upper and lower tubes 212, 216 are similarly arranged. In particular, the second upper tube 210 has a first end 314, referred to herein as a top end 314, and a second end 316, referred to herein as a bottom end 316, opposite the top end 314. The top end 314 is coupled to the crown 204. In the illustrated example, a portion of the second upper tube 212 extends into an opening 318 in the crown 204. In some examples, the second upper tube 212 is coupled to the crown 204 by a cap 320 that is threadably coupled to the top end 314 of the second upper tube 212. Additionally or alternatively, the second upper tube 212 can be coupled to the crown 204 via another mechanical and/or chemical fastening technique (e.g., threaded fasteners, welding, an adhesive, etc.). The second lower tube 216 has a third end 322, referred to herein as a top end 322, and a fourth end 324, referred to herein as a bottom end 324, opposite the top end 322. The second upper tube 212 is inserted into the second lower tube 216. In particular, the bottom end 316 of the second upper tube 212 is disposed within the second lower tube 216. The second upper and lower tubes 212, 216 form a telescopic arrangement and move along a central axis 326 of the second leg 208. The second upper and lower tubes 212, 216 define an interior chamber or region 328. The first and second upper tubes 210, 212 and the first and second lower tubes 214, 216 are moveable between a fully extended position (also referred to as a top-out position) and a fully compressed position (also referred to as a bottom-out position).

In the illustrated example, the front fork 200 includes both a spring 330 and a damper 332. In this example, the spring 330 is disposed in and/or otherwise integrated into the first leg 206, and the damper 332 is disposed in and/or otherwise integrated into the second leg 208. The spring 330 is configured to resist compression of the top ends 300, 314 toward the bottom ends 308, 324 and return the tubes 210, 212, 214, 216 to the extended position after compression occurs. The damper 332 is configured to limit the speed at which the compression/extension occurs and/or otherwise absorb vibrations.

In this example, the spring 330 is implemented as an air spring. The spring 330 includes a pneumatic chamber 334. In this example, the pneumatic chamber 334 is defined by an interior of the first upper tube 210. However, in other examples, the pneumatic chamber 334 can be defined by a separate cylinder or body that is disposed in the first upper tube 210, similar to the damper body 348 in the first upper tube 210. The front fork 200 includes a seal head 336 (e.g., a piston, a plug, a disc, etc.) coupled to and disposed in the first upper tube 210 near the bottom end 302 that seals the bottom of the pneumatic chamber 334. In this example, the steelhead 336 is spaced from the bottom end 302 of the first upper tube 210. The cap 305 seals the top of the pneumatic chamber 334. In some examples, the cap 305 includes a valve 338 (e.g., a Schrader valve) that can be used to fill the pneumatic chamber 334 with fluid (e.g., compressed air).

In the illustrated example, the spring 330 includes a first shaft 340 that is coupled to and extends upward from the bottom end 308 of the first lower tube 214. The first shaft 340 extends through the seal head 336 and into the pneumatic chamber 334. The spring 330 includes a piston 342 that is coupled (e.g., threadably coupled) to an end of the first shaft 340 and disposed in the pneumatic chamber 334 in the first upper tube 210. The piston 342 is slidable within the first upper tube 210. In some examples, a seal is disposed around the piston 342, which creates a seal between the piston 342 and the inner surface of the first upper tube 210.

The piston 342 divides the pneumatic chamber 334 into a first chamber 344, referred to herein as a positive air chamber 344, and a second chamber 346, referred to herein as a negative air chamber 346. In some examples, the positive air chamber 344 is filled with a mass of a pneumatic fluid (e.g., a gas, such as air) having a higher pressure than ambient pressure. Therefore, in this example, the positive air chamber 344 forms a pressurized chamber, sometimes referred to as a highly pressurized zone or positive spring chamber, above the piston 342. The negative air chamber 346 is also filled with pneumatic fluid and forms a negative spring chamber below the piston 342. When the front fork 200 compresses and the ends of the first upper and lower tubes 210, 214 move toward each other, such as when riding over a bump, the first shaft 340 moves the piston 342 toward the top end 300 of the first upper tube 210. As a result, the volume of the positive air chamber 344 decreases and, thus, the pressure of the air within the positive air chamber 344 increases. Conversely, the volume of the negative air chamber 346 increases and therefore the pressure of the air in the negative air chamber 346 decreases. After the compressive force is removed, the increased pressure in the positive air chamber 344 and the decreased pressure in the negative air chamber 346 acts to move the piston 342 away from the top end 300, which pushes the ends of the first upper and lower tubes 210, 214 away from each other, thereby acting as a spring to return the front fork 200 to its original or riding set up. The second upper and lower tubes 212, 216 similarly follow this motion.

In other examples, the spring 330 can be implemented by a physical spring, such as a coil spring. For example, a coil spring can be disposed in the first upper tube 210 between the first shaft 340 and the top end 300 of the first upper tube 210. When the front fork 200 is compressed, the first shaft 340 is moved upward and compresses the coil spring. After the compression, the coil spring acts to expand the front fork 200 back to its original or riding set up.

In the illustrated example, the damper 332 includes a damper body 348 that defines a chamber 350 (e.g., a hydraulic chamber). The damper body 348 is disposed in and coupled to the second upper tube 212. For example, the damper body 348 is coupled to and extends downward from the second cap 320. As such, the damper body 348 is coupled to and disposed in a fixed position in the second upper tube 212. In other examples, the chamber 350 can be formed by the interior of the second upper tube 212. The bottom of the chamber 350 is sealed by a seal head 352. The chamber 350 is filled with fluid. The fluid may be, for example, oil, such as a mineral oil based damping fluid. In other examples, other types of damping fluids may be used (e.g., silicone or glycol type fluids). The damper 332 includes a second shaft 354 (which may be referred to as a damper or piston shaft, rod, or stem). The second shaft 354 is coupled to and extends upward from the bottom end 324 of the second lower tube 216. The second shaft 354 extends upward and through the seal head 352 and into the chamber 350. The damper 332 includes a damper member 356 (which may also be referred to as a piston or mid-valve) disposed in the chamber 350 of the damper body 348. The damper member 356 is coupled to the second shaft 354 and is slidable in the damper body 348. The damper member 356 divides the chamber 350 into two chambers (above and below the damper member 356). When the front fork 200 compresses and the ends of the second upper and lower tubes 212, 216 move toward each other, such as when riding over a bump, the second shaft 354 moves the damper member 356 upward in the chamber 350 toward the top end 314 of the second upper tube 212. During rebound, the damper member 356 moves downward in the chamber 350 away from the top end 314 of the second upper tube 212. The damper member 356 includes one or more channels that enable fluid to flow across the damper member 356, at a restricted rate, between the first and second chambers, thereby damping or slowing the compression/extension movement of the front fork 200.

In some examples, the rebound and compression rates of the damper 332 can be independently controlled. For example, as shown in FIG. 3, the damper 332 includes an accumulation chamber 358. In some examples, when the front fork 200 is compressed, such as during a high compression event, the damper member 356 moves upward in the chamber 350 and forces the fluid through a top of the damper body 348 and into the accumulation chamber 358. The damper 332 includes a spring 360 that biases a piston or diaphragm downward to apply pressure to the fluid in the accumulation chamber 358. In some examples, the resistance of the spring 360 can be adjusted via a compression adjust rod. In some examples, the damper 332 can include one or more adjustment knobs or dials (e.g., on the second cap 320) to adjust one or more parameters of the piston/diaphragm and/or spring 360 to control the rebound and/or compression damping rates.

The spring 330 and the damper 332 include multiple seals. These seals have a static friction that must be overcome to compress or expand the front fork 200. While relatively small, this static friction may cause a delay in the compression or rebound movement, which may cause an undesirable stick slip feeling that can be felt by the rider. Additionally, high frequency vibrations (e.g., above 5 Hz) having a low amplitude may be not absorbed by the spring 330 and the damper 332. Therefore, in some examples, the front fork 200 includes a first example isolator 362 to address the above-noted drawbacks. In this example, the first isolator 362 is associated with the spring 330 in the first leg 206. The first isolator 362 is disposed between and couples the first shaft 340 to the bottom end 308 of first lower tube 214. The first isolator 362 enables relative movement between the first lower tube 214 (which is attached to the front wheel 104 (FIG. 1) and considered the unspring side of the suspension component) and the first shaft 340, which is coupled to the piston 342. In particular, as disclosed in further detail herein, the first isolator 362 includes one or more cushioning members, such as elastomeric members (e.g., rubber pads). The elastomeric member(s) of the first isolator 362 enable(s) relative movement between the first lower tube 214 and the first shaft 340 and, thus, between the first upper and lower tubes 210, 214. As such, the first isolator 362 enables the first lower tube 214 (the unspring mass) to move upward relative to the first upper tube 210 before the breakaway force for the spring 330 and the damper 332 is reached, thereby enabling the front fork 200 absorb the vibrations more quickly during compression. The first isolator 362 also absorbs high frequency, low amplitude vibrations that would otherwise be transmitted through the first upper and lower tubes 210, 214 to the handlebars 114 (FIG. 1). In the illustrated example, the front fork 200 also includes a second isolator 364 associated with the damper 332 in the second leg 208. The second isolator 364 is disposed between and couples the second shaft 354 to the bottom end 324 of the second lower tube 216. The second isolator 380 is substantially the same as the first isolator 362 and similarly allows relative movement between the second lower tube 216 and the second shaft 354 and, thus, between the second upper and lower tubes 212, 216. In the illustrated example, the front fork 200 includes two isolators, one in each of the legs 206, 208. However, in other examples, the front fork 200 may only include one isolator (e.g., only the first isolator 362).

In the illustrated example, the front fork 200 includes a bumper, in this example a jounce bumper 366. The jounce bumper 366 is disposed in the first lower tube 214 of the first leg and, in particular, near the bottom end 308 of the first lower tube 214. The jounce bumper 366 may be constructed of an elastomeric material (e.g., rubber) and is used to cushion the impact during a bottoming-out event. In particular, when the front fork 200 is compressed during a high-speed or high-force compression event, the seal head 336 and/or the bottom end 302 of the first upper tube 210 engages the jounce bumper 366. The jounce bumper 366 deforms and/or compresses before stopping the first upper tube 210 from moving further downward. As such, the jounce bumper 366 helps to reduce or soften the hard stopping point when the front fork 200 is fully compressed. The jounce bumper 366 also affects the end of the spring curve for the spring 330. As disclosed in further detail herein, the position of the jounce bumper 366 is adjustable in the first lower tube 214. For example, the jounce bumper 366 can be moved axially (e.g., up or down in FIG. 3) relative to the first lower tube 214 by actuating a bumper adjuster 365. This enables a user to adjust and/or otherwise control the end spring rate during a bottoming-out event of the front fork 200.

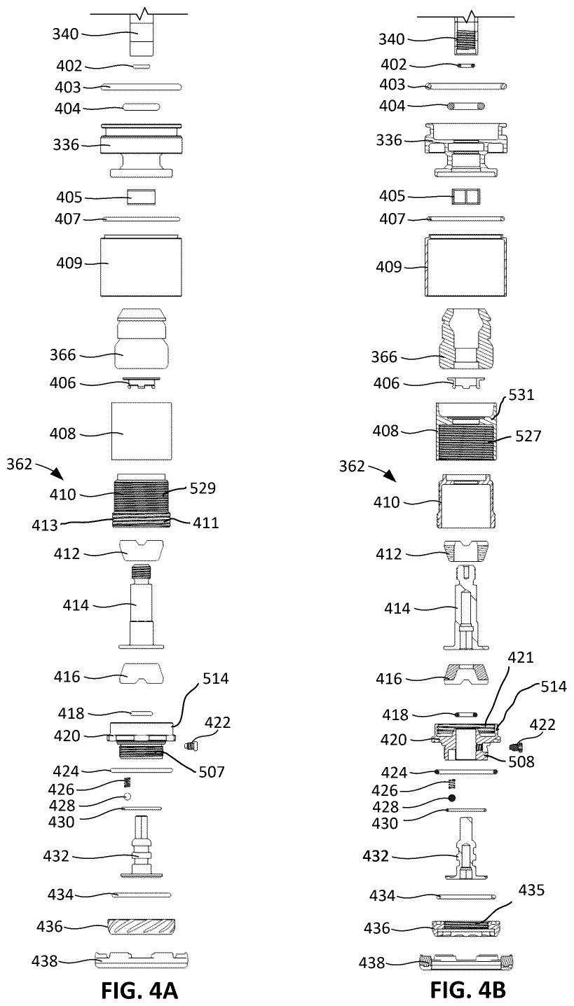

FIG. 4A is an exploded view of the assembly of parts in the first leg 206 including the first shaft 340, the seal head 336, the first isolator 362, the jounce bumper 366 and the bumper adjuster 365. FIG. 4B is a cross-sectional view of the same parts in the exploded view of FIG. 4A. As shown in FIGS. 4A and 4B, the assembly includes O-rings 402, 403, 404, the seal head 336, a bushing 405, an O-ring 407, a seal head spacer 409, the jounce bumper 366, a bushing 406, a bumper carrier 408, an upper isolator body 410, a first cushioning member 412, a coupler 414, a second cushioning member 416, an O-ring 418, a lower isolator body 420, a set screw 422, an O-ring 424, a spring 426, a ball 428, an O-ring 430, a bumper actuator 432, an O-ring 434, a bottom nut 436, and a bottom-out pad 438. These parts are disclosed in further detail herein.

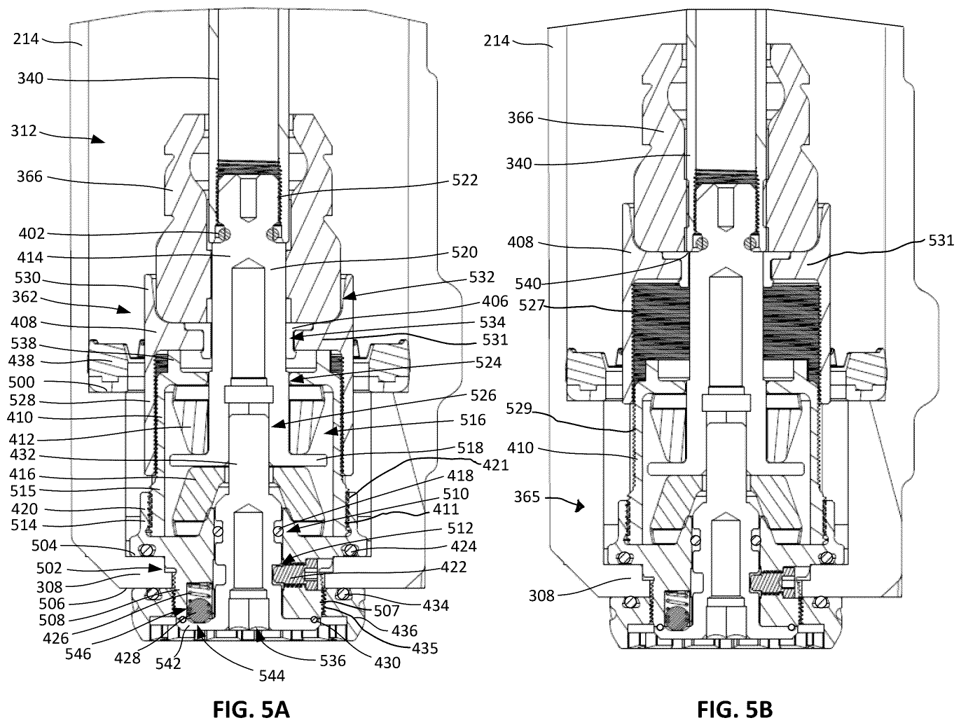

FIG. 5A is an enlarged view of the callout 368 of FIG. 3 showing the first isolator 362 and the jounce bumper 366 in the first lower tube 214. The FIG. 5A shows the jounce bumper 366 in a first position, in this example, a lower-most position. FIG. 5B, which is described in further detail below, shows the jounce bumper 366 moved to a second position, in this embodiment, an upper-most position. The lower-most position and upper-most position may also be referred to as minimum and maximum positions, respectively. The jounce bumper 366 is moveable to a plurality of positions between the lower-most position (FIG. 5A) and the upper-most position (FIG. 5B) by the bumper adjuster 365. The bumper adjuster 365 generally comprises the bumper carrier 408 and the bumper actuator 432.

As shown in FIG. 5A, the bottom-out pad 438 is disposed on a shoulder 500 formed in the first lower tube 214. The bottom-out pad 438 forms a hard stop when the first upper and lower tubes 210, 214 are fully compressed, as shown in further detail herein. In some examples, the bottom-out pad 438 is constructed of rubber. In some examples, the bottom-out pad 438 includes rubber molded onto a plastic bottom.

In the illustrated example of FIG. 5A, the first lower tube 214 has an opening 502 extending between a first side 504 (an internal side) and a second side 506 (an external side) of the bottom end 308. The lower isolator body 420 is disposed in the interior region 312 of the first lower tube 214. The O-ring 424 is disposed in a gland in an upper portion 514 of the lower isolator body 420 and forms a seal between the lower isolator body 420 and the first side 504 of the bottom end 308 to prevent leakage of fluid (e.g., air, oil, etc.). The lower isolator body 420 has a lower portion 508 that extends through the opening 502. The lower portion 508 has external threads 507. The bottom nut 436 has internal threads 435 and is threadably coupled to the lower portion 508 on the lower isolator body 420, which thereby couples the lower isolator body 420 to the bottom end 308 of the first lower tube 214. The bottom nut 436 can be torqued to rigidly secure the lower isolator body 420 to the first lower tube 214. The O-ring 434 is disposed in a gland in the bottom nut 436 and forms a seal (e.g., to block dust) between the bottom nut 436 and the second side 506 of the bottom end 308. In this example, the bumper actuator 432 is implemented as a pin, referred to herein as an adjuster pin 432. The adjuster pin 432 extends through a central passage 510 in the lower isolator body 420 and, thus, through the opening 502 in the bottom end 308 of the first lower tube 214. The adjuster pin 432 accessible by a user from the bottom of the first lower tube 214. The adjuster pin 432 is rotatable in the lower isolator body 420, which causes rotation of the bumper carrier 408, as disclosed in further detail herein. As shown in FIG. 5A, the set screw 422 is screwed into the lower isolator body 420 and extends into a groove 512 on the side of the adjuster pin 432. This allows the adjuster pin 432 to rotate in the lower isolator body 420, but prevents the adjuster pin 432 from moving axially (e.g., up or down) relative to the lower isolator body 420. In the illustrated example, the O-ring 418 is disposed in a gland in the adjuster pin 432 and forms a seal between the adjuster pin 432 and the inner surface of the lower isolator body 420 to prevent leakage of fluid (e.g., air, oil, etc.).

As shown in FIG. 5A, the upper isolator body 410 is threadably coupled to the lower isolator body 420. The upper portion 514 of the lower isolator body 420 has internal threads 421, and a lower portion 413 of the upper isolator body 410 has external threads 411 and is threadably coupled to the upper portion 514 of the lower isolator body 420. In other examples, the upper and lower isolator bodies 410, 420 can be coupled via other mechanical and/or chemical fastening techniques (e.g., welding, an adhesive, a threaded fastener such as a screw or bolt, etc.). The upper and lower isolator bodies 410, 420 are coupled together and form a body 515 (e.g., a housing) that is rigidly coupled to the bottom end 308 of the first lower tube 214. The upper and lower isolator bodies 410, 420 define a cavity 516. As shown in FIG. 5A, the first and second cushioning members 412, 416 are disposed in the cavity 516 and clamped (e.g., axially constrained) between the upper and lower isolator bodies 410, 420.

In this example, the coupler 414 is implemented as a bolt 414. Looking to FIG. 5A, the bolt 414 has a plate portion 518 (e.g., a flange, a disk) and a post portion 520 with a threaded section 522. The plate portion 518 is disposed (e.g., clamped) between the first and second cushioning members 412, 416 in the cavity 516, and the post portion 520 extends outward through an opening 524 in the upper isolator body 410. The threaded section 522 is threaded into the first shaft 340 with the O-ring 402 forming a seal between the bolt 414 and the first shaft 340. As such, the bolt 414 and the first shaft 340 are rigidly coupled and move together. In the illustrated example, the bolt 414 has a bore 526. As shown in FIG. 5A, the adjuster pin 432 extends into the bore 526 of the bolt 414. The bolt 414 is movable (e.g., slidable) axially along the adjuster pin 432. As such, the bolt 414 and the first shaft 340 are moveable axially relative to the first lower tube 214. The adjuster pin 432 and bolt 414 are rotationally keyed. In particular, the adjuster pin 432 and the bore 526 have a matching cross-sectional shape, such as a hexagon. This allows the adjuster pin 432 and the bolt 414 to move (e.g., slide) axially relative to each other, but rotationally fixes the adjuster pin 432 and the bolt 414 such that rotation of the adjuster pin 432 causes rotation of the bolt 414.

In this example, the first and second cushioning members 412, 416 are implemented as elastomeric members. The first and second cushioning members 412, 416 can be constructed of any elastomeric material. In some examples, the first and second cushioning members 412, 416 are constructed of nitrile rubber (e.g., 40 Shore A nitrile rubber). In other examples, the first and second cushioning members 412, 416 can be constructed of other types of rubber (e.g., butyl rubber, ethylene propylene diene monomer (EPDM) rubber, etc.), silicone, polyurethane, or a viscoelastic material. In this example, the first and second cushioning members 412, 416 are ring-shaped. However, in other examples, the first and second cushioning members 412, 416 can be shaped differently.

The first and second cushioning members 412, 416 are engaged with opposite sides of the plate portion 518. Therefore, the first cushioning member 412 biases the plate portion 518 (and, thus, the bolt 414 and the first shaft 340) downward, and the second cushioning member 416 biases the plate portion 518 in the opposite direction. In some examples, the first and second cushioning members 412, 416 are preloaded (i.e., in a slightly deformed and/or compressed state).

The first and second cushioning members 412, 416 elastically deform and/or compress, and expand, in response to compression and rebound forces. For example, when a compressive force is first applied to the front fork 200 (e.g., when riding over a bump), the upper and lower isolator bodies 410, 420 are forced upward and/or the bolt 414 is forced downward. Before the breakaway force is reached, the second cushioning member 416 is deformed and/or compressed between the lower isolator body 420 and the plate portion 518 of the bolt 414, which enables the first lower tube 214 to move upward relative to the first shaft 340 and, thus, upward relative to the first upper tube 210 (FIG. 2). Further, because the plate portion 518 is moved away from the first cushioning member 412, the first cushioning member 412 expands. After the compressive force is removed, the second cushioning member 416 biases the lower isolator body 420 and the plate portion 518 away from each other, which moves the first lower tube 214 downward relative to the first shaft 340 and, thus, downward relative to the first upper tube 210. Similarly, when a rebound (expanding) force is applied to the front fork 200 (e.g., from the spring 330 (FIG. 3)), the first and second cushioning members 412, 416 enable relative movement of the first upper and lower tubes 210, 214 in the opposite direction. In this manner, the first isolator 362 enables relative movement between the first upper and lower tubes 210, 214 before the breakaway forces of the spring 330 and the damper 332 (FIG. 3) are reached. Therefore, unlike known front forks, the example front fork 200 does not require a certain force to overcome some friction or breakaway force to initiate movement. Instead, any net compressive or expansive force can result in relative movement of the first upper and lower tubes 210, 214. This results in less vibrations or shocks transmitted through the front fork 200 to the handlebars 114 (FIG. 1). The first and second cushioning members 412, 416 also absorb high frequency, low amplitude vibrations that may otherwise not be absorbed by the front fork 200. In this example the first isolator 362 include two cushioning members. However, in other examples, only one cushioning member may be implemented. For example, in some instances, only the first cushioning member 412 may be included. Further, while in this example the cushioning members are implemented as elastomeric members, in other examples, the cushioning members can be implemented as springs (e.g., metallic coil springs, leaf springs, etc.) or other types of cushioning members that produce biased movement between two components.

As shown in FIG. 5A and 5B, the bumper carrier 408 is disposed in the first lower tube 214. The bumper carrier 408 can also be referred to as a bumper cup. The bumper carrier 408 is cylindrical. An interior of the bumper carrier 408 includes a flange 531 dividing the bumper carrier into a lower portion 528 and an upper portion 530. The bumper carrier 408 is threadably coupled to the body 515 of the first isolator 362. In particular, the lower portion 528 of the bumper carrier 408 includes internal threads 527 that are engaged with the external threads 529 on the upper isolator body 410. The jounce bumper 366 is coupled to the bumper carrier 408. For example, as shown in FIG. 5A, the upper portion 530 and the flange 531 form a cup shape defining a cavity 532 for receiving the jounce bumper 366. The jounce bumper 366 is disposed in the cavity 532 and contacts the flange 531. In some examples, the jounce bumper 366 is coupled to the bumper carrier 408 via friction fit with the upper portion 530. Additionally or alternatively, the jounce bumper 366 can be coupled to the bumper carrier 408 via other mechanical and/or chemical techniques (e.g., an adhesive, a threaded fastener, etc.). As disclosed in further detail herein, the bumper carrier 408 is axially moveable to adjust the position the jounce bumper 366 in the first lower tube 214.

When the front fork 200 is compressed, the first upper tube 210 (FIG. 3) is moved into the first lower tube 214. If the compressive force is large enough, the first upper tube 210 is moved relatively far into the first lower tube 214 such that the seal head 336 (FIG. 3) contacts the jounce bumper 366. The seal head 336 contacts the jounce bumper 366 first, which deforms and/or compresses the jounce bumper 366 until the first upper tube 210 contacts the bottom-out pad 438. Therefore, in some examples, the engagement with the bottom-out pad 438 defines the fully compressed or bottom-out position of the front fork 200. However, in other examples, the bottom-out pad 438 is not contacted. Instead, the jounce bumper 366 is deformed and/or compressed until its thickness cannot be forcibly reduced anymore, which prevents the first upper tube 210 from moving further into the first lower tube 214 and, thus, defines the fully compressed or bottom-out position of the front fork 200. In either instance, this deformation and/or compression of the jounce bumper 366 provides a more gradual slowing of the tubes 210, 214 before the hard stop at the bottom-out position. As such, the jounce bumper 366 prevents or reduces the abrupt or harsh bottoming-out of the front fork 200.

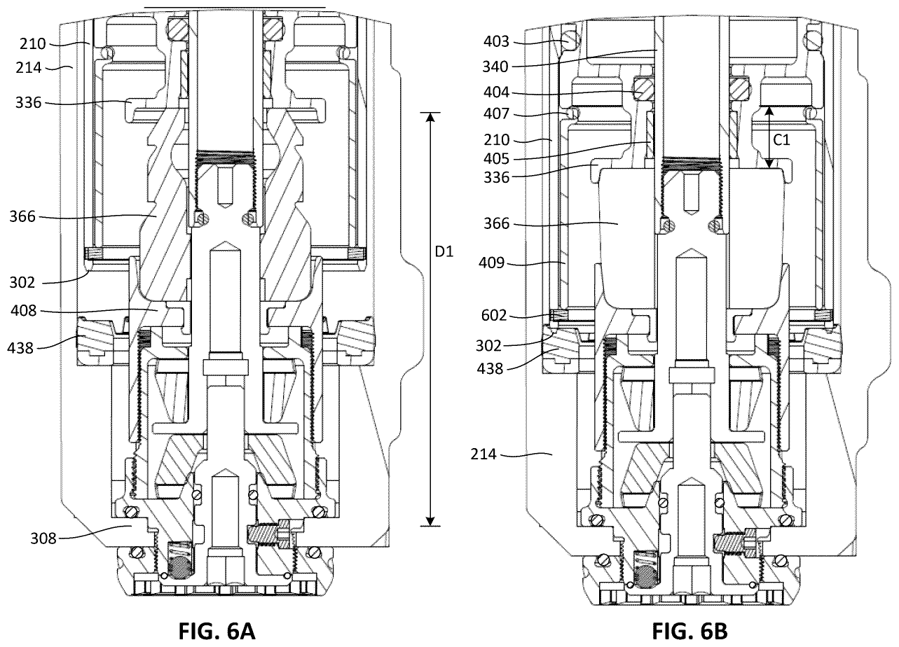

For example, referring briefly to FIG. 6A, FIG. 6A shows the jounce bumper 366 in the lower-most position (FIG. 5A) during a bottoming-out event when the seal head 336 makes initial contact with the jounce bumper 366. In the upper-most position, the top of the jounce bumper 366 is a first distance D1 from the bottom end 308 of the first lower tube 214. As the first upper tube 210 continues to move downward, the jounce bumper 366 is deformed and/or compressed between the seal head 336 and the bumper carrier 408. In some examples, the jounce bumper 366 is constructed of an elastomeric and/or compressible material such as microcellular or foam material such as microcellular urethane (MDU), rubber (e.g., nitrile rubber, butyl rubber, ethylene propylene diene monomer (EPDM) rubber, etc.), silicone, and/or polyurethane. The first upper tube 210 continues to move downward until the deformation/compression of the jounce bumper 366 stops the movement and/or the bottom end 302 of the first upper tube 210 contacts the bottom-out pad 438, as shown in FIG. 6B. This contact with the bottom-out pad 438 provides a hard stop that prevents the first upper tube 210 from moving further into the first lower tube 214. As shown in FIG. 6B, the jounce bumper 366 has been deformed and/or compressed (in the axial direction) a first amount C1 from the expanded state in FIG. 6A. The deformation and/or compression of the jounce bumper 366 over the first amount C1 provides a gradual slowing of the first upper tube 210 before reaching the hard stop.

As shown in FIG. 6B, the O-ring 404 is carried by the seal head 336 and seals against the first shaft 340 to prevent fluid leakage between the seal head 336 and the first shaft 340. The bushing 405 enables the seal head 366 to slide relative to the first shaft 340. Further, the O-ring 403 is carried by the seal head 336 and seals against the inner surface of the first upper tube 210 to prevent fluid leakage between the seal head 336 and the first upper tube 210. In the illustrated example, the seal head spacer 409 is disposed in the first upper tube 210. The seal head spacer 409 is secured in the first upper tube 210 by a retainer 602 (e.g., a circlip). The seal head spacer 409 maintains the seal head 336 at a certain position in the first upper tube 210 and prevents the seal head 336 from being ejected from the bottom end 302 of the first upper tube 210. The O-ring 407 is clamped between the seal head 336 and the seal head spacer 409.

Referring back to FIG. 5A, the position of the jounce bumper 366 can be changed to adjust the position at which the seal head 336 (FIG. 3) contacts the jounce bumper 366 during a bottoming-out event. As shown in FIG. 5A, the post portion 520 of the of the bolt 414 extends through an opening 534 in the bumper carrier 408. The bushing 406 is disposed in the opening 534 and coupled to the flange 531 of the bumper carrier 408 (e.g., via friction fit). The post portion 520 of the bolt 414 extends through the bushing 406. The bushing 406 is rotationally keyed to the post portion 520 of the bolt 414. As such, the bolt 414 and the bumper carrier 408 are rotationally key (e.g., rotationally fixed) while still allowing the bolt 414 and the bumper carrier 408 to move (e.g., slide) axially relative to each other. The bushing 406 forms a low friction surface for the bolt 414 to slide relative to the bumper carrier 408. This reduces wear on the bolt 414 and the bumper carrier 408. In some examples, the bushing 406 is constructed of polytetrafluorethylene (e.g., Teflon®). In other examples, the bushing 406 can be constructed of another material, such as polyoxymethylene or acetal (e.g., Delrin®).

To adjust the position of the jounce bumper 366, a user can rotate the adjuster pin 432. In some examples, the adjuster pin 432 can be rotated by inserting a tool (e.g., an Allen wrench) into a hex bore 536 and rotating the adjuster pin 432. Additionally or alternatively, the adjuster pin 432 can be rotated by hand without a tool. In some examples, the adjuster pin 432 can have an enlarged knob shape that can be grasped by a user. As disclosed above, the adjuster pin 432 and the bolt 414 are keyed together, such that rotation of the adjuster pin 432 causes rotation of the bolt 414. Further, the bolt 414 and the bumper carrier 408 are keyed together (e.g., via the bushing 406). As such, rotation of the adjuster pin 432 causes rotation the bumper carrier 408. The bumper carrier 408 is threadably engaged with the upper isolator body 410, which is rigidly coupled to the first lower tube 214. As such, rotation of the bumper carrier 408 causes the bumper carrier 408 and the jounce bumper 366 to move axially (e.g., up or down) relative to the upper isolator body 410 and, thus, relative to the first lower tube 214. For example, FIG. 5B shows the bumper carrier 408 after being rotated and translated upward to an upper-most position. As shown, the bumper carrier 408 has been moved upward relative to the upper isolator body 410. Therefore, the jounce bumper 366 is spaced further from the bottom end 308 of the first lower tube 214. As such, during a bottoming-out event, the seal head 336 (FIG. 3) engages the jounce bumper 366 at an earlier position, which affects the end of the spring curve. The axial movement of the bumper carrier 408 and the jounce bumper 366 is independent of the bolt 414 and the first shaft 340. In other words, moving the bumper carrier 408 and the jounce bumper 366 up or down does not cause the bolt 414 or the first shaft 340 to move up or down. Instead, the bumper carrier 408 and the jounce bumper 366 slide linearly up or down the first shaft 340. However, because the bolt 414 is rigidly coupled to the first shaft 340, rotation of the bolt 414 also causes rotation of the first shaft 340 (and may also cause rotation of the piston 342 (FIG. 3). This rotation, however, does not affect the performance of the spring 330.

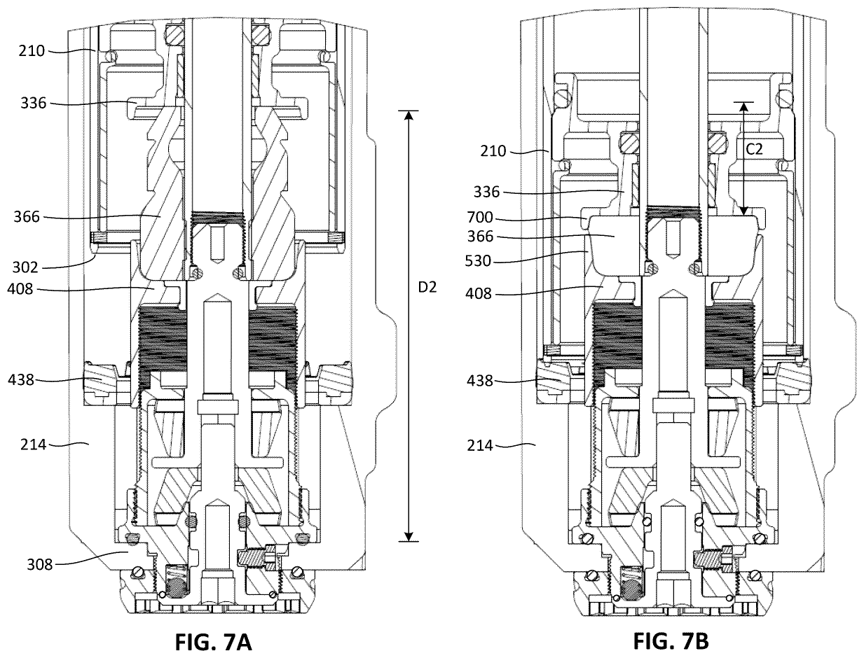

Referring briefly to FIG. 7A, FIG. 7A shows the jounce bumper 366 in the upper-most position (FIG. 5B) during a bottoming-out event when the seal head 336 making initial contact with the jounce bumper 366. In the upper-most position, the top of the jounce bumper 366 is a second distance D2 from the bottom end 308 of the first lower tube 214. The second distance D2 is greater than the first distance D1 of FIG. 6A. As such, the seal head 336 contacts the jounce bumper 366 at an earlier position in the downstroke. As the first upper tube 210 continues to move downward, the jounce bumper 366 is deformed and/or compressed between the seal head 336 and the bumper carrier 408. The jounce bumper 366 is deformed and/or compressed until the bottom end 302 of the first upper tube 210 has contacted the bottom-out pad 438, as shown in FIG. 7B. The first upper tube 210 continues to move downward until the deformation and/or compression of the jounce bumper 366 stops the movement and/or the bottom end 302 of the first upper tube 210 has contacted the bottom-out pad 438, as shown in FIG. 7B. This contact with the bottom-out pad 438 provides a hard stop that prevents the first upper tube 210 from moving further into the first lower tube 214. As shown in FIG. 7B, the jounce bumper 366 has been deformed and/or compressed a second amount C2 from the expanded state in FIG. 7A. This second amount C2 is greater than the first amount C1 in FIG. 6B. Therefore, the jounce deformation/compression event occurs over a longer stroke when the jounce bumper 366 is in the upper-most position. This provides a more gradual damping before the fully compressed or bottom-out position. A user can adjust the position of the jounce bumper 366 to any position between the lower-most position (FIG. 5A) and the upper-most position (FIG. 5B) based on their desired preference.

As shown in FIG. 7B, the seal head 336 has a lower portion 700. The lower portion 700 of the seal head 336 and the upper portion 530 of the bumper carrier 408 are used to radially constrain the jounce bumper 366. In particular, when the jounce bumper 366 is deformed and/or compressed, the jounce bumper 366 is squeezed axially, which forces the jounce bumper 366 to expand radially. However, the jounce bumper 366 is radially constrained within the lower portion 700 of the seal head 336 and the upper portion 530 of the bumper carrier 408. When the jounce bumper 366 has been maxed out or completely fills the space between the lower and upper portions 700, 530, the jounce bumper 366 acts as a hard material that stops further movement. As such, the inner diameter of the portions 700, 530 and/or the length of the portions 700, 530 controls the amount the jounce bumper 366 can be deformed and/or compressed and, thus, controls the spring rate of the jounce bumper 366. The diameter of the portions 700, 530 and/or the length of the portions 700, 530 can be increased or decreased depending on the desired compression rate. In other examples, the seal head 336 and/or the bumper carrier 408 may not have these portions, which may result in a less stiff jounce bumper action. As shown in FIGS. 5A, 6A, and 7A, the jounce bumper 366 has a tapered profile (e.g., the top of the jounce bumper 366 is thinner) with one or more grooves in the outer radial surface of the jounce bumper 366. This enables the jounce bumper 366 to fold at the thinner section(s). However, in other examples, the jounce bumper 366 can have other geometries that do not fold.

The jounce bumper 366 can be moved to any position between the lower-most position (FIG. 5A) and the upper-most position (FIG. 5B). In some examples, the front fork 200 includes one or more features to limit the bumper carrier 408 from moving beyond the lower-most position (FIG. 5A) and the upper-most position (FIG. 5B). For example, as shown in FIG. 5A, the bumper carrier 408 is engaged with an upward extending portion 538 of the upper isolator body 410. This prevents the bumper carrier 408 from being moved further downward and thereby defines the lower-most position of the jounce bumper 366. As shown in FIG. 5B, the bushing 406 is engaged with a bottom end 540 of the first shaft 340. This prevents the bumper carrier 408 from being moved further upward and thereby defines the upper-most position of the jounce bumper 366. In other examples, other structures or features can be used to define these upper and lower limits of the bumper carrier 408.

In some examples, the front fork 200 includes a position mechanism that defines one or more discrete positions between the lower-most position and the upper-most position. For example, as shown in FIG. 5A, the adjuster pin 432 has a flange 542 with multiple detents 544 (e.g., grooves, recesses) spaced apart and arranged circumferentially. Only one of the detents 544 is visible in FIG. 5A. As shown in FIG. 5A, the ball 428 and spring 426 are disposed in a bore 546 in the lower isolator body 420 and biased into one of the detents 544 on the flange 542 of the adjuster pin 432. The ball 428 holds the adjuster pin 432 in its current rotational position until a sufficient torque is applied (e.g., by a user with a tool), at which point the ball 428 is pushed upward and the adjuster pin 432 can rotate freely. When another detent 544 is aligned with the ball 428, the ball 428 slides into the detent 544 to hold the adjuster pin 432 in its current rotational position. Therefore, the adjuster pin 432 is rotatable to a plurality of discrete positions via a ball and detent mechanism, which defines one or more discrete positions of the jounce bumper 366. The flange 542 can have any number of detents to define any number of discrete positions. In the illustrated example, the O-ring 430 forms a seal (e.g., to block dust) between the flange 542 and the lower isolator body 420.

In this example, the bumper carrier 408 uses the upper isolator body 410 as a threaded structure to facilitate the up-down movement. Therefore, this design leverages the structure of the first isolator 362. However, in other examples, the front fork 200 may not include the first isolator 362. Instead, the first shaft 340 can be fixedly coupled to the bottom end 308 of the first lower tube 214 (e.g., via a threaded fastener). In such an example, the bumper carrier 408 may be threadably coupled to another threaded structure (e.g., a threaded sleeve or bolt) in the first lower tube 214. Therefore, the first isolator 362 is not a required element for the adjusting the jounce bumper 366.

While in some examples the front fork 200 is configured such that the jounce bumper 366 is engaged by the seal head 336, in other examples, the front fork 200 can be configured such that the bottom end 308 of the first upper tube 210 or another structure coupled to the first upper tube 210 contacts the jounce bumper 366. Therefore, the jounce bumper 366 is contacted by the first upper tube 210 or a structure (e.g., the seal head 336) coupled to the first upper tube 210 during a bottoming-out event before the first upper and lower tubes 210, 214 reach the fully compressed positioned.

While the example adjustable jounce bumper 366 is described in connection with the first leg 206 having the spring 330, a similar adjustable jounce can be implemented in the second leg 208 that has the damper 332. Therefore, the example jounce bumper 366 is not limited to just the spring side. In some examples, the damper 332 may include an adjustment knob on the bottom end of the second leg 208 for adjusting a parameter of the damper 332, such as the compression or rebounding damping rate. In such an instance, the adjustment knob is typically centrally located.

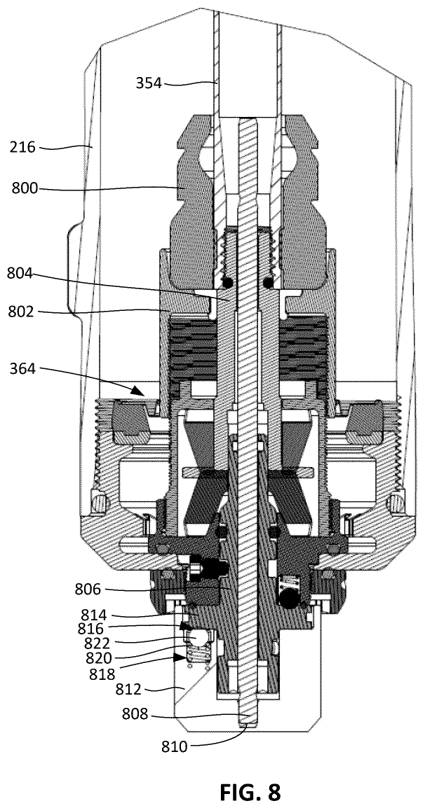

FIG. 8 is a cross-sectional view of an example jounce bumper 800 and bumper carrier 802 implemented in the second lower tube 216 of the second leg 208 (which incorporates the damper 332 (FIG. 3)). The second isolator 364, the jounce bumper 800, and the bumper carrier 802 operate in substantially the same manner as the first isolator 362, the jounce bumper 366, and the bumper carrier 408 described above and, thus, a description of these components is not repeated. As shown in FIG. 8, the front fork 200 includes a bolt 804 and an adjuster pin 806, which are similar to the bolt 414 and the adjuster pin 432 disclosed above. However, in this example, the damper 332 (FIG. 3) includes a damper adjustment rod 808 that extends through central channels in the bolt 804 and the adjuster pin 806 and into the second shaft 354. A bottom end 810 of the damper adjustment rod 808 is disposed below the adjuster pin 806. The damper adjustment rod 808 can be rotated to adjust a fluid flow rate across the damper member 356 (FIG. 3), which affects the damping rate of the damper 332. As shown in FIG. 8, a damper adjustment knob 812 is coupled to the damper adjustment rod 808. The damper adjustment knob 812 is rotatably coupled to the adjuster pin 806. As such, the damper adjustment knob 812 can rotate independent of the adjuster pin 806. A user can rotate the damper adjustment knob 812 to rotate the damper adjustment rod 808. In some examples, the damper adjustment knob 812 is removable to enable a user to access the adjuster pin 806 to adjust the position of the jounce bumper 800. In the illustrated example, the front fork 200 includes a ball and detent mechanism to enable the damper adjustment knob to move to discrete positions. In the illustrated example, a flange 814 of the adjuster pin 806 has a plurality of detents 816 (one of which is visible in FIG. 8). The damper adjustment knob 812 has a bore 818 with a spring 820 and ball 822. The ball 822 is biased into the detents 816 on the adjuster pin 806. This allows the damper adjustment knob 812 (and, thus, the damper adjustment rod 808) to be rotated to a plurality of discrete rotational positions.

While in some examples disclosed above the jounce adjustment is controlled externally, such as by rotating the adjuster pin 432, 806, in other examples, the position of the jounce bumper can involve an internal adjustment by the user. For example, a user may partially disassemble the front fork 200 and change the position of the jounce bumper 366, 800 by manually rotating the bumper carrier 408, 802 to move the position of the jounce bumper 366, 800 up or down. In such an example, the front fork 200 may not include the adjuster pin 432, 806. In another example, the bolt 414, 804 may have e-clip grooves, and a user can adjust the bumper carrier 408, 802 up or down on the bolt 414, 804 using a removable e-clip.

While the example adjustable jounce bumpers are described in connection with a front suspension fork, the example adjustable jounce bumpers disclosed herein can be similarly implemented in connection with other types of suspension components. For example, any of the example adjustable jounce bumpers disclosed herein can be similarly implemented in the rear shock absorber 136 (FIG. 1).

From the foregoing, it will be appreciated that example apparatus have been disclosed that enable a user to have adjustment of the bumper engagement and therefore the end stroke rate of the spring during a bottoming-out event.

Examples and combinations of examples disclosed herein include the following:

Example 1 is a front fork for a bicycle, the front fork comprising: a leg including a first tube and a second tube, the first tube having a first end and a second end, the second tube having a third end and a fourth end, the first and second tubes configured in a telescopic arrangement, the first and second tubes moveable between a fully extended position and a fully compressed position; and a bumper disposed in the second tube near the fourth end, the bumper to be contacted during a bottoming-out event before the first and second tubes reach the fully compressed positioned, wherein a position of the bumper is adjustable in the second tube.

Example 2 includes the front fork any preceding example, wherein the second end of the first tube is disposed within the second tube.

Example 3 includes the front fork any preceding example, wherein the second tube includes a wheel attachment portion extending from the fourth end, the wheel attachment portion to be coupled to a hub on a wheel of the bicycle.

Example 4 includes the front fork any preceding example, further including an adjuster comprising a bumper carrier in the second tube, the bumper coupled to the bumper carrier, wherein the bumper carrier is axially moveable to adjust the position the bumper in the second tube.

Example 5 includes the front fork any preceding example, wherein the bumper carrier comprises an upper portion to radially constrain the bumper.

Example 6 includes the front fork any preceding example, further including a body rigidly coupled the fourth end of the second tube, the bumper carrier is threadably coupled with the body, such that rotation of the bumper carrier causes the bumper carrier and the bumper to move axially in the second tube.

Example 7 includes the front fork of any preceding example, further including a seal head disposed in the first tube, wherein the seal head is to contact the bumper during the bottoming-out event such that the bumper is compressed between the seal head and the bumper carrier.

Example 8 includes the front fork any preceding example, wherein the body has external threads and the bumper carrier has internal threads engaged with the external threads of the body.

Example 9 includes the front fork of any preceding example, further including an adjuster pin extending through an opening in the fourth end of the second tube, the adjuster pin accessible by a user, wherein rotation of the adjuster pin causes rotation of the bumper carrier.

Example 10 includes the front fork of any preceding example, wherein the adjuster pin is rotatable to a plurality of discrete positions via a ball and detent mechanism.

Example 11 includes the front fork of any preceding example, further including a coupler, the adjuster pin and the coupler being rotationally coupled such that rotation of the adjuster pin causes rotation of the coupler.

Example 12 includes the front fork of any preceding example, wherein the coupler and the bumper carrier are rotationally coupled such that rotation of the coupler causes rotation of the bumper carrier.

Example 13 includes the front fork of any preceding example, wherein the adjuster pin extends into a bore of the coupler such that the coupler is axially slidable along the adjuster pin.

Example 14 includes the front fork of any preceding example, further including a shaft coupled to a piston in the first tube, the coupler rigidly coupled to the shaft, the coupler having a plate portion disposed between two cushioning members.

Example 15 includes the front fork of any preceding example, further including a bottom-out pad disposed on a shoulder formed in the second tube, the bottom-out pad to be engaged by the first tube when the first and second tubes are in the fully compressed position.

Example 16 is a front fork for a bicycle, the front fork comprising: a leg including an upper tube and a lower tube, the upper tube having a first top end and a first bottom end, the lower tube having a second top end and a second bottom end, the upper and lower tubes configured in a telescopic arrangement with the first bottom end of the upper tube disposed in the lower tube; a bumper disposed in the lower tube near the second bottom end; and an adjuster pin to cause axial movement of the bumper in the lower tube, wherein the bumper is moveable between a lower-most position in which a top of the bumper is a first distance from the second bottom end of the lower tube and an upper-most position in which the top of the bumper is a second distance from the second bottom end of the lower tube, the second distance being greater than the first distance.

Example 17 includes the front fork of any preceding example, further including a bumper carrier disposed in the lower tube, the bumper coupled to the bumper carrier.

Example 18 includes the front fork of any preceding example, further including a body rigidly coupled the second bottom end of the lower tube, the bumper carrier is threadably coupled with the body, wherein rotation of the adjuster pin causes rotation of the bumper carrier, which causes the bumper carrier to move axially.

Example 19 includes the front fork of any preceding example, wherein the body has external threads and the bumper carrier has internal threads engaged with the external threads of the body.

Example 20 includes the front fork of any preceding example, wherein the bumper carrier has an upper portion to radially constrain the bumper.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

What is claimed is:

1. A front fork for a bicycle, the front fork comprising:
a leg including a first tube and a second tube, the first tube having a first end and a second end opposite the first end, the second tube having a third end and a fourth end opposite the third end, the first and second tubes configured in a telescopic arrangement, the first and second tubes moveable between a fully extended position and a fully compressed position; and
a bumper disposed in the second tube near the fourth end, the bumper to be contacted during a bottoming-out event before the first and second tubes reach the fully compressed positioned, wherein a position of the bumper is adjustable in the second tube.

2. The front fork of claim 1, wherein the second end of the first tube is disposed within the second tube.

3. The front fork of claim 1, wherein the second tube includes a wheel attachment portion extending from the fourth end, the wheel attachment portion to be coupled to a hub on a wheel of the bicycle.

4. The front fork of claim 1, further comprising a bumper carrier in the second tube, the bumper coupled to the bumper carrier, wherein the bumper carrier is axially moveable to adjust the position of the bumper in the second tube.

5. The front fork of claim 4, wherein an upper portion of the bumper carrier radially constrains the bumper.

6. The front fork of claim 4, further comprising a body rigidly coupled the fourth end of the second tube, the bumper carrier is threadably coupled with the body, such that rotation of the bumper carrier causes the bumper carrier and the bumper to move axially in the second tube.

7. The front fork of claim 4, further comprising a seal head disposed in the first tube, wherein the seal head is configured to contact the bumper during the bottoming-out event such that the bumper is compressed between the seal head and the bumper carrier.

8. The front fork of claim 6, wherein the body has external threads and the bumper carrier has internal threads engaged with the external threads of the body.

9. The front fork of claim 4, further comprising an adjuster pin extending through an opening in the fourth end of the second tube, the adjuster pin accessible by a user, wherein rotation of the adjuster pin causes rotation of the bumper carrier.

10. The front fork of claim 9, wherein the adjuster pin is rotatable between a plurality of discrete positions via a ball and detent mechanism.

11. The front fork of claim 9, further including a coupler, the adjuster pin and the coupler being rotationally coupled such that rotation of the adjuster pin causes rotation of the coupler.

12. The front fork of claim 11, wherein the coupler and the bumper carrier are rotationally coupled such that rotation of the coupler causes rotation of the bumper carrier.

13. The front fork of claim 12, wherein the adjuster pin extends into a bore of the coupler such that the coupler is axially slidable along the adjuster pin.

14. The front fork of claim 12, further including a shaft coupled to a piston in the first tube, the coupler rigidly coupled to the shaft, the coupler having a plate portion disposed between two cushioning members.

15. The front fork of claim 1, further including a bottom-out pad disposed on a shoulder formed in the second tube, the bottom-out pad to be engaged by the first tube when the first and second tubes are in the fully compressed position.

16. A front fork for a bicycle, the front fork comprising:
a leg including an upper tube and a lower tube, the upper tube having a first top end and a first bottom end, the lower tube having a second top end and a second bottom end, the upper and lower tubes configured in a telescopic arrangement with the first bottom end of the upper tube disposed in the lower tube;
a bumper disposed in the lower tube near the second bottom end; and
an adjuster pin to cause axial movement of the bumper in the lower tube, wherein the bumper is moveable between a lower-most position in which a top of the bumper is a first distance from the second bottom end of the lower tube and an upper-most position in which the top of the bumper is a second distance from the second bottom end of the lower tube, the second distance being greater than the first distance.

17. The front fork of claim 16, further including a bumper carrier disposed in the lower tube, the bumper coupled to the bumper carrier.

18. The front fork of claim 17, further including a body rigidly coupled the second bottom end of the lower tube, the bumper carrier is threadably coupled with the body, wherein rotation of the adjuster pin causes rotation of the bumper carrier, which causes the bumper carrier to move axially.

19. The front fork of claim 18, wherein the body has external threads and the bumper carrier has internal threads engaged with the external threads of the body.

20. The front fork of claim 17, wherein the bumper carrier has an upper portion to radially constrain the bumper.
